(19) United States
(12) Patent Application Publication
(10) Pub. No.: US 2021/0195906 A1
(43) Pub. Date: Jul. 1, 2021

(54) Single Serve Portion Evaporated Milk Package

(71) Applicant: Behrouz F-Haghighi, Toronto (CA)

(72) Inventor: Behrouz F-Haghighi, Toronto (CA)

(21) Appl. No.: 17/202,338

(22) Filed: Mar. 15, 2021

(51) Int. Cl. A23C 1/12; B65D 85/80

(52) U.S. Cl. CPC A23C 1/12; B65D 85/80

(57) ABSTRACT

Packaged single serve portion evaporated milk.

### BACKGROUND

So far evaporated milk has been used mostly for baking and as such it is always marketed in cans and. But this product could be used for many other purposes as well including using as coffee creamer or whitener. On the other hand, cream and milk have been used as additives for coffee but they have their problems. Too much milk in coffee makes it cold and too little does not have enough effect on coffee taste. Using cream in coffee introduces an additional problem namely increasing the fat content and its associated unwanted effects.

### DESCRIPTION

Evaporated milk packaged and supplied in SINGLE SERVE PORTION CONTAINERS could be used in different new ways. For the first and most part evaporated milk is a better additive for coffee and other hot or maybe some cold drinks. It delivers more taste and nutrition than milk in smaller amounts and less fat than cream in higher portions. As a completely new use it could be added to hot or cold water to make milk drink that could substitute the milk itself and acidophilus milk in some extent with more nutritious values than both. Evaporated milk in single serve portion containers is not available at present.

1. Evaporated milk package containing single serve portion.
